(19) United States
(12) Patent Application Publication
(10) Pub. No.: US 2026/0226222 A1
(43) Pub. Date: Aug. 6, 2026

(54) PROCESS FOR MANUFACTURING POLYURETHANE FOAM

(71) Applicant: Galata Chemicals, LLC, Jersey City, NJ (US)

(72) Inventor: Peter FRENKEL, Danbury, CT (US)

(21) Appl. No.: 19/152,062

(22) PCT Filed: Jan. 11, 2024
(86) PCT No.: PCT/US2024/011144

§ 371 Date: Jul. 30, 2025

Related U.S. Application Data
(60) Provisional application No. 63/443,066, filed on Feb. 3, 2023.
(60) Provisional application No. 63/453,911, filed on Mar. 22, 2023.

(51) Int. Cl. C08G 18/24; C08G 18/22; C08G 18/75; C08L 75/04

(52) U.S. Cl. CPC C08G 18/246; C08G 18/222; C08G 18/755; C08L 75/04; C08G 2110/0008; C08G 2110/005; C08G 2110/0083; C08L 2203/14

(57) ABSTRACT

A process comprising reacting:
at least one organic isocyanate having at least two isocyanate groups; and
at least one polyol having two or more functional groups that react with the organic isocyanate,
in the presence of a catalyst comprising a dimethyltin dicarboxylate, thereby forming a polyurethane foam.

### FIELD OF THE INVENTION

The present invention relates to polyurethane foam. More particularly, the present invention relates to polyurethane foams having low volatility, and the process and tin-containing catalysts for preparing them.

### BACKGROUND OF THE INVENTION

The use of tin-based materials as catalysts for the production of polyurethane foam is well known. Preparation of polyurethane foams has long required that catalysts used in the process were effective, efficient, of relatively low toxicity, and preferably result in the articles with low emissions. As an example, stannous di-2-ethylhexanoate, has been the most commonly used tin catalyst for manufacturing flexible polyurethane foams in the world. However, as a result of the substance evaluation by European Chemical Agency, this tin-based catalyst was found to belong to a CMR (Carcinogenic, Mutagenic, Reprotoxic) category of particularly dangerous chemical substances that can cause harmful effects to humans. Stannous di-2-ethylhexanoate will be classified as a reprotoxicant of Category 1B on Nov. 1, 2023 in Europe. This category is the most severe for reproductive toxicity, and generally signals clear evidence of an adverse effect on sexual function and fertility or on development in the absence of other toxic effects.

Currently, the only commercially available alternative to stannous di-2-ethylhexanoate, is stannous dineodecanoate. Work on other tin-based catalysts has been ongoing.

U.S. Pat. No. 3,397,158 discloses a number of catalyst compositions suitable to catalyze formation of polyurethane foams. The catalysts include stannous dioleate, stannous dioctoate, mixtures of stannous dioleate and stannous dioctoate, combinations of stannous octoate and tertiary amines, stannous salts of acids having from 1 to 18 carbon atoms, such as stannous distearate, stannous diacetate and stannous di-2-ethylhexanoate among others, combinations of stannous salts of acids having from 1 to 18 carbon atoms with tertiary amines. Other catalysts mentioned in the patent description include stannous dichloride, dialkyltin oxides, trialkyltin oxides and dialkyltin salts of carboxylic acids having from 1 to 18 carbon atoms and their combinations with tertiary amines. The dialkyltin salts of carboxylic acids likely known at the time were those of relatively low catalytic activity for use in preparation of flexible polyurethane foams, where alkyl groups were butyl and possibly octyl.

U.S. Patent Application Publication 2010/0305228 describes catalysts that are suitable for the preparation of polyurethane foams. The catalysts were stannous salts of branched organic acids having from 10 to 16 carbon atoms, such as 2-butyloctanoic acid and 2-hexyldecanoic acid. EP 2289960 also refers to tin salts of branched carboxylic acids, such as tin propylheptanoate, for reduced emissions.

U.S. Patent Application Publication 2013/0041057 discloses catalysts that are suitable for the preparation of polyurethane foams. The catalysts were tin diricinoleate, zinc diricinoleate and their combinations. U.S. Patent Application Publication 2013/0041058 discloses catalysts that are also suitable for the preparation of polyurethane foams. The catalysts were combinations of tin diricinoleate, zinc diricinoleate and tin carboxylate that is not tin ricinoleate. In both applications, dibutyltin dilaurate was mentioned as suitable for the production of high resiliency foams, such as slabstock, but its use was avoided due to health and ecological reasons.

U.S. Patent 2015/0337072 discloses use of a tin neodecanoate catalyst for flexible polyurethane systems.

Nevertheless, a continuing need exists for polyurethane foam processes utilizing low toxicity catalysts that results in low VOC-containing materials.

### SUMMARY OF THE INVENTION

The subject matter of the present disclosure relates to catalysts and processes for producing polyurethane foam, and the polyurethane foam produced according to such processes.

In one embodiment, the present disclosure relates to a process comprising reacting at least one organic isocyanate having at least two isocyanate groups, and at least one polyol having two or more functional groups that react with the organic isocyanate in the presence of a catalyst comprising a dimethyltin dicarboxylate, thereby forming a flexible polyurethane foam.

In another embodiment, the present disclosure provides a catalyst for the production of flexible polyurethane foam comprising a dimethyltin dicarboxylate.

In still another embodiment, the present disclosure provides a flexible polyurethane foam made by a process comprising reacting at least one organic isocyanate having at least two isocyanate groups, and at least one polyol having two or more functional groups that react with the organic isocyanate in the presence of a catalyst comprising a dimethyltin dicarboxylate.

In one embodiment, the present disclosure relates to a process comprising reacting at least one organic isocyanate having at least two isocyanate groups, and at least one polyol having two or more functional groups that react with the organic isocyanate in the presence of a catalyst comprising a mixture of a dimethyltin dicarboxylate and a zinc dicarboxylate, thereby forming a flexible polyurethane foam.

In another embodiment, the present disclosure provides a catalyst for the production of flexible polyurethane foam comprising a mixture of a dimethyltin dicarboxylate and a zinc dicarboxylate.

In still another embodiment, the present disclosure provides a flexible polyurethane foam made by a process comprising reacting at least one organic isocyanate having at least two isocyanate groups, and at least one polyol having two or more functional groups that react with the organic isocyanate in the presence of a catalyst comprising a mixture of a dimethyltin dicarboxylate and a zinc dicarboxylate.

### DETAILED DESCRIPTION OF THE INVENTION

The subject matter of the present disclosure provides a process for producing polyurethane foams. In one embodiment, the present disclosure relates to a process comprising reacting at least one organic isocyanate having at least two isocyanate groups, and at least one polyol having two or more functional groups that react with the organic isocyanate in the presence of a catalyst comprising a dimethyltin dicarboxylate, thereby forming a polyurethane foam. These polyurethane systems employ catalysts having advantageous toxicity profiles, and produce foams having low VOC and enhanced compression set properties.

### Polyurethane Foams

For the purposes of this specification, the expression “polyurethane foam” refers to cellular products as obtained by reacting a polyol, at least one organic isocyanate having at least two isocyanate groups (polyisocyanate) with isocyanate-reactive hydrogen containing compounds in the presence of a dimethyltin dicarboxylate or a mixture of a dimethyltin dicarboxylate with a zinc dicarboxylate catalyst. Preferably, the foams are flexible foams. More preferably, the flexible foams are primarily open-celled materials, in contrast to rigid foams which have a high proportion of closed cells. For the purposes of this specification, the term “primarily open-celled” means that there is a higher proportion of open-celled foam than closed-cell foam. In open cell materials, gas from within the polyurethane material is released during foam formation, creating empty spaces.

### Polyols

Polyols which are useful in the process of the invention include organic substances containing two or more isocyanate-reactive groups, such as polyether polyols (obtained by reacting poly-alcohols or polyamines with alkylene oxides) and polyester polyols (esters of polybasic carboxylic acids (for example, adipic acid) with glycols. Polyols derived from renewable feedstocks can also be used, for example, natural oil-based polyols, such as soy polyols.

Preferably, the ratio between the isocyanate groups and the polyol hydroxyl groups in the foam, i.e., the so-called NCO (Isocyanate) index, is generally between 40 to 400. The index is a dimensionless value (not a percent), as it is the ratio of the number of equivalents of isocyanate used relative to the number of equivalents of polyol times 100. An index value above 100 means an excess of isocyanate; less than 100 means a shortage of isocyanate, or an excess of polyol. An index of 100 indicates about perfect stoichiometry: where every reactive site in the isocyanate is reacted with every hydroxyl site in the polyol.

The polyols normally have hydroxyl numbers in the range of about 10 to about 600, where the hydroxyl number is defined by the equation:

$$Hydroxyl number = ( 56 , 1000 * F ) / ( MW ) ,$$

where
F is the polyol functionality defined as the average number of hydroxyl groups per molecule of polyol; and
MW is the number average molecular weight of the polyol.

Preferably, the functionality of the polyols is 2 to 4 and most preferably 2.3 to 3.5. Preferably, the polyol hydroxyl numbers are about 15 to about 85 mg KOH/g for flexible foams. In contrast, polyol hydroxyl numbers for rigid foams are typically higher and range between about 250 and 500 mg KOH/g.

### Polyisocyanate Compound

Preferably, the polyisocyanates suitable for use in preparing the inventive polyurethane foams, are selected from 4,4′-diphenylmethane diisocyanate (MDI), toluene diisocyanate (TDI), hexamethylene diisocyanate (HMDI), and isophorone diisocyanate (IPDI), xylylene diisocyanate (XDI), or polymethylenepolyphenyl polyisocyanate (so-called crude MDI).

### Catalysts

Historically, dialkyltin dicarboxylates have not been used as effective catalysts in preparation of flexible polyurethane foams, because in addition to the two carboxylate groups chemically bonded to each tin atom, all dialkyltin dicarboxylates also contain two alkyl groups chemically bonded with each tin atom, and these alkyl groups are expected to sterically hinder access of other reactants to the tin atoms. In this way, their catalytic activity in the reaction is reduced and/or delayed, and the reaction is slower compared to stannous dicarboxylates. That has been the case with dibutyltin dicarboxylates and dioctyltin dicarboxylates that have not been commonly used for manufacturing flexible polyurethane foams, since they impart longer Pot Life, a latent period of time after the catalyst is introduced into the system and until any pronounced catalytic action is imparted by these catalysts. Higher Pot Life is undesirable in this application because it adversely affects throughput of the process and foam quality.

It has surprisingly been found that dimethyltin dicarboxylates, especially dimethyltin dineodecanoate and dimethyltin diricinoleate as well as mixtures of dimethyltin dicarboxylates with a zinc dicarboxylates, as catalysts satisfy the most rigorous requirements for use in the preparation of flexible open-cell foams based on either ether polyols or ester polyols. In particular, it was found here that dimethyltin dicarboxylates or mixtures of a dimethyltin dicarboxylate with a zinc dicarboxylate when used for catalyzing polyurethane foam systems imparted Pot Life as well as rate of reaction similar to that of tin dicarboxylates, and also imparted comparable-to-superior physical characteristics to the foams.

In addition to providing shorter Pot Life and physical characteristics, the claimed catalysts have desirably lower toxicity.

GHS Classification Criteria for Reproductive Toxicity is broadly reported.

Reproductive toxicity refers to adverse effects of a chemical substance/mixture on sexual function and fertility in adult males and females, as well as developmental toxicity in the offspring. Developmental toxicity pertains to adverse toxic effects to the developing embryo or fetus.

There are 3 hazard categories for reproductive toxicity under GHS.

Category 1A: Known human reproductive toxicants-based on evidence from humans.

Category 1B: Presumed human reproductive toxicants-largely based on animal studies.

Category 2: Suspected human reproductive toxicant-Evidence from animal and/or human studies is limited.

Non-reprotoxic substances do not exhibit any characteristics described above.

Dimethyltin dicarboxylate catalysts of this invention can be described by the general formula:

(Me)₂Sn(OOR)₂,

where R is a linear, branched, cyclic, saturated, unsaturated or aromatic hydrocarbon group containing from 1 to 18 carbon atoms. The hydrocarbon group may optionally contain a hydroxyl group. The preferred catalysts of this invention include dimethytin diacetate, dimethyltin dipropionate, dimetyltin di-2-ethylhexanoate, dimethyltin dineodecanoate, dimethyltin didodecanoate, dimethyltin dioleate, dimethyltin diricinoleate and mixtures thereof. Dimethyltin dineodecanoate and dimetyltin diricinoleate are the most preferred. The dimethyltin dicarboxylates may contain methyltin tricarboxylates at 1 to 10%. Optionally, dibutyltin dicarboxylates and/or dioctyltin dicarboxylates may be added to dimethyltin dicarboxylates of this invention at 5 to 25%.

Zinc dicarboxylates that can be a component in the tin-containing catalyst mixture include zinc salts of organic acids containing from 1 to 18 carbon atoms. The organic acids may optionally contain a hydroxyl group in their chemical structure. The preferred zinc dicarboxylate include zinc dipropionate, zinc dioctanoate, zinc di-iso-nonanoate, zinc di-neodecanoate, zinc di-decanoate, zinc di-dodecanoate, zinc diricinoleate and zinc dioleate. Zinc di-iso-nonanoate and zinc di-neo-decanoate as well as zinc diricinoleate are preferred. Zinc content of catalyst mixtures of dimethyltin dicarboxylate with zinc dicarboxylates of this invention ranges at 0.5 to 10%. The mixtures can be prepared by blending the tin-containing and zinc-containing components at ambient or elevated temperatures of 50-150° C. over 0.5 to 2.0 hours. When a catalyst mixture is used, dimethyltin dicarboxylate is present in an amount from 75 to 95%, and the zinc dicarboxylate is present in an amount from 5 to 25%.

The above catalysts can be used as technically pure or as solutions in a solvent. When a solvent is used, preferred solvents are glycols (such as monoethylene glycol, diethylene glycol, propylene glycol, 1,3-propanediol, 1,4-butanediol, dipropylene glycol), polyols (including glycerol), esters (including phthalates), linear, branched or cyclic organic acids containing from 9 to 18 carbon atoms (such as iso-nonanoic acid, neodecanoic acid, dodecanoic acid), polyethers, hydrocarbons and mixtures thereof. More preferably, the solvent is selected from glycols and esters. The relative amounts of solvent/catalyst (including zinc dicarboxylates) used typically vary from 25/75 to 75/25 wt %.

According to this invention, the catalysts are suitable for catalyzing the preparation of flexible polyurethane foams with one or more organic isocyanates having two or more organic isocyanate groups, and one or more polyols having two or more hydroxyl functional groups that can react with isocyanates. The catalysts may be used in preparation of polyurethane foams at amounts ranging from 0.01 to 1 pphp (parts by weight per 100 weight parts of polyol), preferably from 0.05 to 0.8 pphp.

Other reaction components that may be used to produce the polyurethane foam catalyzed with dimethyltin dicarboxylates of this invention, include tertiary amine catalysts, foam stabilizers, blowing agents including water, flame retardants, anti-scorching agents, surfactants and/or emulsifiers.

### Foam Stabilizer

When a foam stabilizer is used in the preparation of the polyurethane foam, a silicone foam stabilizer or a fluorinated foam stabilizer is preferably used. More preferably, a silicone foam stabilizer is used. Most preferably, a silicone foam stabilizer containing polyoxyalkylene/dimethylpolysiloxane copolymer as the main component, is used. When a foam stabilizer is used in the process of manufacturing the polyurethane foam, it is preferably present in an amount of 1-5 phpp.

### Flame Retardants

When flame retardants are present in the polyurethane foam, typical examples include tris (1,3-dichloroisopropyl) phosphate (TDCPP), triphenyl phosphate (TPP), 2-ethylhexyl, 2,3,4,5-tetrabromobenzoate (TBB), bis(2-ethylhexyl) 2,3,4,5-tetrabromophthalate (TBPH), tris(2-chloro-2-propyl) phosphate (TCPP), tris(2-chloroethyl) phosphate (TCEP), melamine (2,4,6-triamino-1,3,5 triazine, and mixtures thereof.

### Blowing Agents

Water can be used as a blowing agent in the polyurethane foam of the present invention. Blowing agents based on hydrocarbons or halogenated hydrocarbons can also be used. When an organic blowing agent is used, it can typically be chosen from hydrofluoro-olefin (HFO), hydro chlorofluorocarbons (HCFC) and the chlorofluorocarbons (CFC), such as trichloromonofluorocarbon (CFC 11) and dichloromethane (methylene chloride). When present, the blowing agents are added in an amount from 2 to 7 parts per hundred parts of polyol (phpp).

Flexible polyurethane foam applications include, refrigerator insulation, spray foam, packaging foam, mattresses, furniture, automotive seating foam, head rest, roofing liner, shoe sole, carpet backing foam, sealing foam and sound absorbing foam.

The following examples further detail and explain preparation, testing and comparative characteristics of polyurethane systems catalyzed by dimethyltin dicarboxylates or mixtures of a dimethyltin dicarboxylate with a zinc dicarboxylate. Those skilled in the art will recognize many variations that are within the spirit of the invention and scope of the claims.

### Examples

### Catalytic Activity Test

Comparative catalytic activity of selected tin-containing catalysts was determined with the use of Dielectric Polarization Analyzer SubCASE HT (Format Messtechnik GmbH) that converts the dielectric conductivity signal to Pot Life and Cure Time (among others) of curing polymer systems. Pot Life was determined by the instrument as time between the mixing the reactants and beginning of the polymerization process at 10% reduction in dielectrical properties from the initial point. Cure Time is calculated as the time between the maximum cure rate point and the point at which the maximum rate is slowed down by 25%. The polyurethane test formulation used for screening catalytic activity of the selected tin-containing catalysts with the use of SubCASE HT is shown in Table 1.

TABLE 1
Polyurethane Test Formulation

| Component | Amount per Test, g |
|---|---|
| Carpol GP-700 (polyol) | 67.14 |
| Isophorone Diisocyanate (IPDI) | 32.86 |
| Tin-containing Catalyst | 0.1-0.2 |

The selected catalysts were tested at loadings of the same tin content. The following catalysts were tested for comparative catalytic activity: stannous di-2-ethylhexanoate, stannous dineodecanoate, stannous diricinoleate, dimethyltin dioleate and dimethyltin dineodecanoate. A catalyst was added to the polyol and mixed at 400 rpm until thoroughly dispersed. IPDI was then added to the polyol/catalyst mixture and mixed for 20 seconds at 400 rpm before introducing the mixture into the SubCASE HT instrument and starting the kinetics measurements. The instrument temperature was set to 30° C. Results of the comparative catalytic activity test for Pot Life and Cure Time of the selected tin-containing catalysts are in Table 2.

TABLE 2
Comparative catalytic activity of the selected tin-containing catalysts

| | | | | | Cure |
|---|---|---|---|---|---|
| Example | | Weight*, | Pot Life, | Cure Time, | Time-Pot |
| No. | Tin-containing Catalyst | g | sec. | sec. | Life, sec |
| 1 | Stannous di(2-ethylhexanoate) | 0.100 | 311 | 420 | 109 |
| | (29.0% tin content) - control | | | | |
| 2 | Stannous dineodecanoate | 0.132 | 404 | 741 | 337 |
| | (22.0% tin content) - control | | | | |
| 3 | Stannous diricinoleate | 0.213 | 560 | 895 | 335 |
| | (13.6% tin content) - control | | | | |
| 4 | Dimethyltin diricinoleate | 0.208 | 471 | 928 | 457 |
| | (13.95% tin content) | | | | |
| 5 | Dimethyltin dioleate | 0.175 | 602 | 1135 | 533 |
| | (16.6% tin content) | | | | |
| 6 | Dimetyltin dineodecanoate | 0.122 | 374 | 695 | 321 |
| | (23.6% tin content) | | | | |

*The tested catalysts were loaded at amounts that introduced the same amount of tin (0.029 g) into the screening formulation

The efficiency of stannous diricinoleate (Example 3) control and dimethyltin dioleate (Example 5) as tin-containing catalysts for polyurethane foam were the lowest. Both catalysts resulted in relatively long Pot Life of 560 and 602 seconds, respectively, even when added at the same tin amount as compared to other tested catalysts such as the stannous di-2-ethylhexanoate (Example 1) and stannous dineodecanoate (Example 2) controls. Pot Life imparted by these controls was 311 and 404 seconds, respectively. Interestingly, dimethyltin diricinoleate of this invention (Example 4) imparted Pot Life that was 471 seconds that was shorter than that of stannous diricinoleate (560 seconds) (Example 3) control, while their Cure Times were about the same (928 and 895 seconds, respectively).

Pot Life imparted by dimethyltin dineodecanoate (374 seconds) (Example 6) was surprisingly and notably shorter than that of stannous dineodecanoate (471 seconds) (Example 2) control. The same was true for the Cure Time imparted by these two catalysts (695 and 741 seconds, respectively). So, dimethyltin dineodecanoate of this invention was similar to and somewhat faster and more efficient than stannous dineodecanoate, and therefore even closer to stannous di-2-ethylhexanoate in terms of its catalytic activity.

### VOC Content (Determined Via the Fog Test)

The content of Volatile Organic Compounds (VOCs) of the specimens prepared with the selected tin-containing catalysts during the SubCASE HT catalytic activity experiments was measured. As described in the Catalytic Activity Test, the prepared specimens contained the selected catalysts added at equal tin content. The specimens were cut to fit the Fog test apparatus and subjected to the Fog Test according to the DIN 75201-B method.

A pre-weighed test specimen was placed into a beaker. A pre-weighed sheet of aluminum foil was held in place over the top of the beaker. The beaker was placed in the Fog Test chamber and held there at 100° C. for 16 hours, while maintaining temperature of the aluminum foil at 21° C. The amount of “Fog” (or VOC) was determined by measuring the weight gain of the aluminum foil sheet after the test was completed. VOC content was expressed in ppm as weight loss of the specimen. The obtained results are in Table 3.

TABLE 3
Results of Fog Test

| | | | VOCs content |
|---|---|---|---|
| | | | as weight loss |
| Example | | Weight*, | of Test |
| No. | Tin-containing Catalyst | g | Specimen, ppm |
| 7 | Stannous di-2-ethylhexanolate | 0.100 | 29 |
| | (control) | | |
| 8 | Stannous diricinoleate | 0.213 | 9 |
| | (control) | | |
| 9 | Dimethyltin diricinoleate | 0.208 | 12 |
| 10 | Dimethyltin dineodecanoate | 0.122 | 37 |

*The tested catalysts were loaded at amounts that introduced the same amount of tin (0.029 g)

The Fog Test demonstrated that at catalyst loadings contributing the same amount of tin, the VOC content generated with the use of dimethyltin dineodecanoate (Example 10) was comparable to that of stannous di-2-ethylhexanoate (Example 7) control (37 and 29 ppm, respectively), while the amount of VOCs generated with the use of dimethyltin diricinoleate (Example 9) was comparable to that of stannous diricinoleate (Example 8) control (12 and 9 ppm, respectively).

In addition to the above Examples carried out in the screening polyurethane formulation, actual flexible polyurethane foam specimens were prepared and tested for their performance characteristics.

The flexible polyurethane foam formulation is in Table 4.

TABLE 4
Tested polyurethane foam formulation (target
density 1.4 pcf; TDI Index 122)

| | Amount per |
|---|---|
| Component | Test, pphp |
| Carpol GP-3510 (polyol) | 100 |
| Conventional silicone | 1.3 |
| Blow Amine catalyst | 0.32 |
| Water | 4.76 |
| Tin- or Tin-Zinc-containing Catalyst | 0.23 |

Testing results of the prepared foams are in Table 5. The tested catalysts included stannous di(2-ethylhexanoate) (Example Control 1), stannous dineodecanoate (Example Control 2), dimethyltin dineodecanoate (Example 11), 90/10 dimethyltin dineodecanoate/zinc dineodecanoate (Example 12) and dimethyltin diricinoleate (Example 13).

TABLE 5
Testing results of the prepared foams.

| | Example | Example | | | |
|---|---|---|---|---|---|
| Parameters | Control 1 | Control 2 | Example 11 | Example 12 | Example 13 |
| Cream time, sec. | 17 | 15 | 18 | 17 | 17 |
| Density, lbs/ft3 | 1.31 | 1.32 | 1.37 | 1.32 | 1.39 |
| Tensile, psi | 14 | 14 | 15 | 16 | 14 |
| Resiliency, % | 30 | 28 | 20 | 27 | 35 |
| % Elongation | 97 | 97 | 107 | 167 | 93 |
| Permeability, scfm | 0.7 | 0.6 | 0.3 | 0.4 | 4.4 |

According to the experimental data in Table 5, Example 11, Example 12 and Example 13 catalysts of this invention resulted in comparable to Example Control 1 and Example Control 2 Cream Time (time at which the clear mixture of components of Table 4 turned creamy and started to expand; it indicates the initial rate of this catalytic process), foam density, tensile strength and resiliency. Compared to Example Control 1 and Example Control 2, Example 11 and Example 12 catalysts resulted in substantially increased elongation (97% vs. 107 and 167%; the increase is about 31 and 72%, respectively). Compared to the controls, the Example 13 catalyst resulted in substantially increased permeability of the obtained foam (0.6-0.7 vs. 4.4) that is essential and highly desirable for the preparation of open cell slabstock foam materials.

### Toxicological Characteristics of Tin-Containing Catalysts

The CMR classification of the selected tin-containing catalysts is listed in Table 6.

TABLE 6
CMR classification of the selected tin-containing catalysts

| Tin-containing Catalysts | CAS Number | CMR Classification | Comments |
|---|---|---|---|
| Dibutyltin dilaurate (control) | 77-58-7 | Reprotox. of Cat. 1B | Effective Jan. 12, 2018 |
| | | Mutagen of Cat. 2 | |
| Dioctyltin dilaurate (control) | 3648-18-8 | Reprotox. of Cat. 1B | Effective Jan. 3, 2022 |
| Stannous di-2-ethylhexanoate | 301-10-0 | Reprotox. of Cat. 2 | Current |
| (control) | | Reprotox. of Cat. 1B | Effective Jan. 11, 2023 |
| Stannous dineodecanoate | 49556-16-3 | Not CMR | Not harmonized |
| (control) | | | |
| Stannous diricinoleate | EC 700-814-2 | Not CMR | Not harmonized |
| (control) | | | |
| Dimetyltin diricinoleate | 3955-81-5 | Reprotox. of Cat. 2 | Not in EC inventory |
| Dimethyltin dioleate | 3865-34-7 | Reprotox. of Cat. 2 | Not harmonized |
| Dimetyltin dineodecanoate | 68928-76-7 | Reprotox. of Cat. 2 | Not harmonized |
| Dimethyltin diacetate | 13293-57-7 | Reprotox. of Cat. 2 | Not in EC inventory |

Information in Table 6 demonstrates that commonly used primarily in rigid polyurethane foam articles dibutyltin dilaurate and dioctyltin dilaurate catalysts are reprotoxicants of category 1B. Stannous di-2-ethylhexanoate is currently a reprotoxicant of category 2 but will be classified as a reprotoxicant of category 1B in 2023. Stannous diricinoleate and Stannous dineodecanoate are the only control catalysts that are classified as a non-CMR. Among dimethyltin dicarboxylate catalysts of this invention, dimethyltin dioleate, dimethyltin diricinoleate dimethyltin diacetate and dimethyltin dineodecanoate are classified as reprotoxicants of category 2, the same classification that was and currently is applied to the industry standard stannous di-2-ethylhexanoate over a long period of time. So, overall, many dimethyltin dicarboxylate catalysts are less toxic than many other tin-containing catalysts known to be used in polyurethane systems including flexible polyurethane foam.

We claim:

1. A process comprising reacting:
at least one organic isocyanate having at least two isocyanate groups; and
at least one polyol having two or more functional groups that react with the organic isocyanate,
in the presence of a catalyst comprising a dimethyltin dicarboxylate, thereby forming a polyurethane foam.

2. The process of claim 1 further comprising at least one reaction component selected from tertiary amine catalysts, chain extenders, silicone surfactants, foam stabilizers, blowing agents, flame retardants, anti-scorching agents, emulsifiers or mixtures thereof.

3. The process of claim 1 wherein the organic isocyanate is selected from toluene diisocyanate (TDI), diphenylmethane diisocyanate (MDI), polymethylenepolyphenyl polyisocyanate, isophorone diisocyanate, hexamethylene diisocyanate and mixtures thereof.

4. The process of claim 1 wherein the polyurethane foam is primarily an open cell foam.

5. The process of claim 1 wherein the polyurethane foam has a density of 0.5 to 2.5 lb/ft³.

6. The process of claim 1 wherein the catalyst is selected from dimethytin diacetate, dimethyltin dipropionate, dimethyltin di-2-ethylhexanoate, dimethyltin dineodecanoate, dimethyltin didodecanoate, dimethyltin dioleate, dimethyltin diricinoleate, and their mixtures.

7. A catalyst for the production of polyurethane foam comprising a dimethyltin dicarboxylate.

8. The catalyst of claim 7 where the carboxylate group is a linear, branched, cyclic, saturated, unsaturated or aromatic hydrocarbon group containing from 1 to 18 carbon atoms and may contain a hydroxy-groups.

9. The catalyst according to claim 7 wherein the dimethyltin dicarboxylate is selected from dimethytin diacetate, dimethyltin dipropionate, dimetyltin di-2-ethylhexanoate, dimethyltin dineodecanoate, dimethyltin didodecanoate, dimethyltin dioleate, dimethyltin diricinoleate, or their mixtures.

10. The catalyst according to claim 9, where the dimethyltin dicarboxylate comprises dimethyltin dineodecanoate, dimethyltin diricinoleate and their mixtures.

11. The catalyst according to claim 7, further comprising one or more solvents.

12. The process according to claim 1, wherein the catalyst is present in an amount of 0.01 to 1 pphp (parts by weight per 100 weight parts of polyol).

13. The process of claim 12 wherein the catalyst is present in an amount from 0.05 to 0.8 pphp.

14. A polyurethane foam made according to the process of claim 1.

15. The polyurethane foam of claim 14 having primarily an open cell structure.

16. The process according to claim 1, wherein the polyurethane foam system is a flexible polyurethane foam, a viscoelastic foam, a high resiliency foam, a semi-rigid polyurethane foam, a thermoformable polyurethane foam or an integral foam.

17. The process of claim 16 wherein the polyurethane foam is a flexible foam.

18. The process according to claim 1, wherein the produced polyurethane foam has improved physical/mechanical properties (elongation), or thermal or sound-insulating performance characteristics compared to foams produced with identical components and conditions except the catalyst that is selected from stannous dicarboxylates.

19. The process according to claim 1, wherein the produced polyurethane foam has increased permeability compared to foams produced with identical components and conditions except the catalyst that is selected from stannous dicarboxylates.

20. A process comprising reacting:
at least one organic isocyanate having at least two isocyanate groups; and
at least one polyol having two or more functional groups that react with the organic isocyanate,
in the presence of a catalyst comprising a mixture of a dimethyltin dicarboxylate and a zinc dicarboxylate, thereby forming a polyurethane foam.

21. The process of claim 20 further comprising at least one reaction component selected from tertiary amine catalysts, chain extenders, silicone surfactants, foam stabilizers, blowing agents, flame retardants, anti-scorching agents, emulsifiers or mixtures thereof.

22. The process of claim 20 wherein the organic isocyanate is selected from toluene diisocyanate (TDI), diphenylmethane diisocyanate (MDI), polymethylenepolyphenyl polyisocyanate, isophorone diisocyanate, hexamethylene diisocyanate and mixtures thereof.

23. The process of claim 20 wherein the polyurethane foam is primarily an open cell foam.

24. The process of claim 20 wherein the polyurethane foam has a density of 0.5 to 2.5 lb/ft³.

25. The process of claim 20 wherein the catalyst is a mixture of a dimethyltin dicarboxylate and a zinc dicarboxylate, the dimethyltin dicarboxylate being selected from dimethytin diacetate, dimethyltin dipropionate, dimethyltin di-2-ethylhexanoate, dimethyltin dineodecanoate, dimethyltin didodecanoate, dimethyltin dioleate, dimethyltin diricinoleate, and their mixtures, and the zinc dicarboxylate being selected from zinc dipropionate, zinc dioctoate, zinc di-iso-nonanoate, zinc di-neodecanoate, zinc di-decanoate, zinc di-dodecanoate, zinc diricinoleate and zinc dioleate and mixtures thereof.

26. The process of claim 25, wherein the catalyst comprises a mixture of dimethyltin dineodecanoate or dimethyltin diricinoleate with zinc di-iso-nonanoate, zinc dineodecanoate or zinc diricinoleate.

27. A catalyst for the production of flexible polyurethane foam comprising a mixture of a dimethyltin dicarboxylate and a zinc dicarboxylate.

28. The catalyst of claim 27 where the carboxylate group of the dimethyltin dicarboxylate and zinc dicarboxylate are independently selected from a linear, branched, cyclic, saturated, unsaturated or aromatic hydrocarbon group containing from 1 to 18 carbon atoms and the hydrocarbon groups may contain hydroxyl groups in their structure.

29. The catalyst according to claim 28 wherein the dimethyltin dicarboxylate is selected from dimethytin diacetate, dimethyltin dipropionate, dimetyltin di-2-ethylhexanoate, dimethyltin dineodecanoate, dimethyltin didodecanoate, dimethyltin dioleate, dimethyltin diricinoleate, and the zinc dicarboxylate is selected from zinc dipropionate, zinc dioctoate, zinc di-iso-nonanoate, zinc di-neodecanoate, zinc di-decanoate, zinc di-dodecanoate, zinc diricinoleate and zinc dioleate and mixtures thereof.

30. The catalyst according to claim 29, where the catalyst is a mixture of dimethyltin dineodecanoate or dimethytin diricinoleate with zinc di-iso-nonanoate, zinc dineodecanoate or zinc diricinoleate.

31. The catalyst according to claim 27, further comprising one or more solvents.

32. The process according to claim 20, wherein the catalyst is present in an amount of 0.01 to 1 pphp (parts by weight per 100 weight parts of polyol).

33. The process of claim 32 wherein the catalyst is present in an amount from 0.05 to 0.8 pphp.

34. A flexible polyurethane foam made according to the process of claim 20.

35. The polyurethane foam of claim 34 having primarily an open cell structure.

36. The process according to claim 20, wherein the polyurethane foam system is a flexible polyurethane foam, a viscoelastic foam, a high resiliency foam, a semi-rigid polyurethane foam, a thermoformable polyurethane foam or an integral foam.

37. The process according to claim 20, wherein the produced polyurethane foam has improved physical/mechanical properties, such as elongation, or thermal or sound-insulating performance characteristics compared to foams produced with identical components and conditions except the catalyst that is stannous dicarboxylates.

38. The process according to claim 20, wherein the produced polyurethane foam has increased permeability compared to foams produced with identical components and conditions except the catalyst that is stannous dicarboxylates.
